(19) United States
(12) Patent Application Publication
(10) Pub. No.: US 2010/0009104 A1
(43) Pub. Date: Jan. 14, 2010

(54) Laminate with Natural Fiber Composite

(75) Inventors: Scott P. Greelis, Moorhead, MN (US); Paul A. Malmanger, Fargo, ND (US)

Correspondence Address: FISH & RICHARDSON P.C., PO BOX 1022, MINNEAPOLIS, MN, 55440-1022, US

(73) Assignee: Composite America, LLC, Fargo, ND (US)

(21) Appl. No.: 12/489,992

(22) Filed: Jun. 23, 2009

Related U.S. Application Data
(60) Provisional application No. 61/080,020, filed on Jul. 11, 2008.

(51) Int. Cl. B32B 1/02; B32B 21/08; B32B 21/14; B32B 21/04; B32B 3/12; B32B 3/00; A61G 17/007; A61G 17/00; B32B 3/30

(52) U.S. Cl. 428/35.6; 428/537.1; 428/535; 428/511; 428/507; 428/481; 428/116; 428/172; 27/1; 428/180

(57) ABSTRACT

A laminate is described that includes a cover layer and a substrate layer. The substrate layer includes a natural fiber composite where natural fibers are bonded together by a polymer binder.

### CROSS REFERENCE TO RELATED APPLICATIONS

This application claims priority under 35 USC §119(e) to U.S. Provisional Patent Application Ser. No. 61/080,020, filed on Jul. 11, 2008, the entire contents of which are hereby incorporated by reference.

### TECHNICAL FIELD

This disclosure relates to a laminate with natural fiber composite and a process for making the laminate.

### BACKGROUND

A laminate is a material that is made by bonding together, often with an adhesive, two or more layers of same or different material, typically under heat and/or pressure. Laminates vary from flexible foil film laminates to rigid circuit board materials. For example, Formica is a plastic laminate of paper or fabric with melamine resin that can be used as a hard, durable surface. Plywood is a laminate of wood plies or veneers that can be used to make wooden beams that are larger and stronger than can be obtained from single pieces of wood.

### SUMMARY

A laminate is described that includes a cover layer and a substrate layer. The substrate layer includes a natural fiber composite where natural fibers are bonded together by a polymer binder. The cover layer may include woods, veneers, plastics, or counter top materials. The substrate layer may include ridges, waffles, honeycombs, ribbons or combination thereof. The natural fibers may include bast fibers that may include hemp, kenaf, jute, flax, banana, or combination thereof. The polymer binder may include a thermoplastic polymer, a thermosetting polymer, or combination thereof. In some embodiments, the thermoplastic binder includes a polypropylene. In some embodiments, the polymer binder includes a biopolymer resin that may include a biodegradable aliphatic polyester, a resin that is derived from a vegetable oil or sugar, or combination thereof. In some embodiments, the biodegradable aliphatic polyester comprises a polylactic acid (PLA). In some embodiments, the biopolymer resin is derived from a soy polyol. In some embodiments, the biopolymer resin includes a poly(sugar acrylate).

### DESCRIPTIONS OF THE DRAWINGS

FIGS. 1A-1C shows three exemplary embodiments of a laminate with natural fiber composite; and

FIG. 2 shows an exemplary method for making a laminate with natural fiber composite.

Like reference symbols in the various drawings indicate like elements.

### DETAILED DESCRIPTION

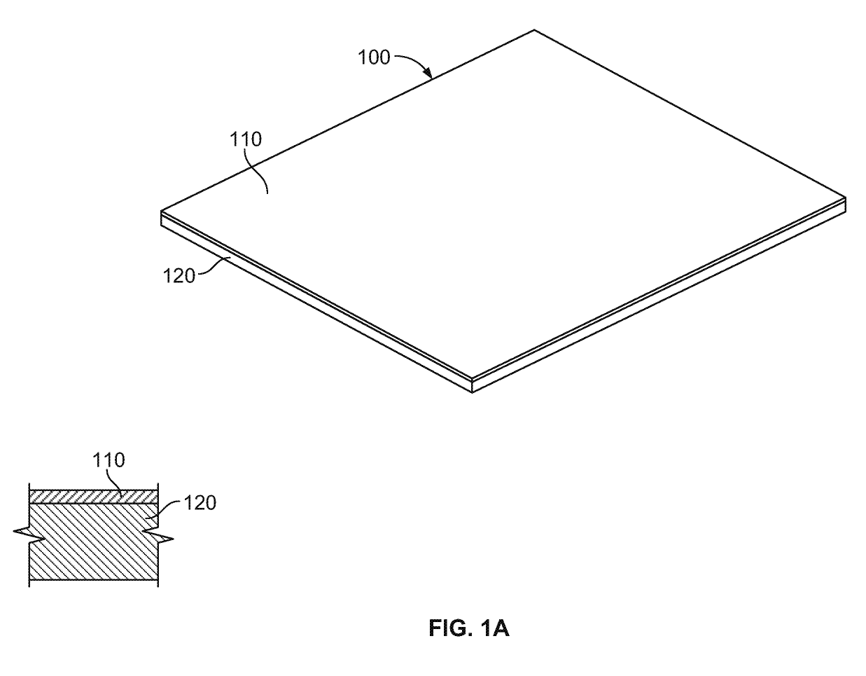

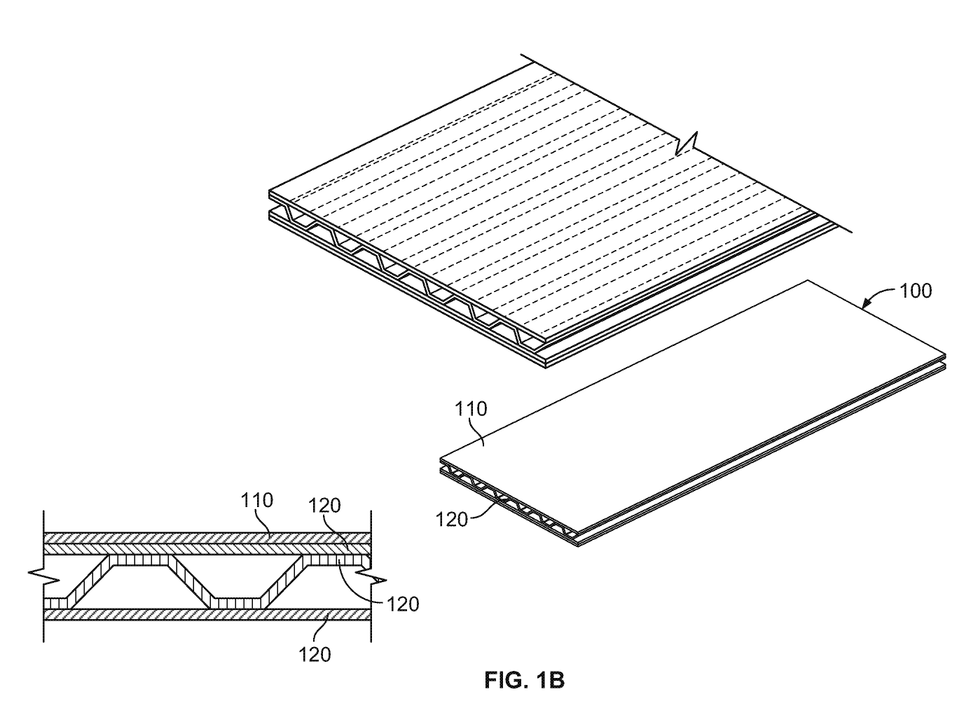

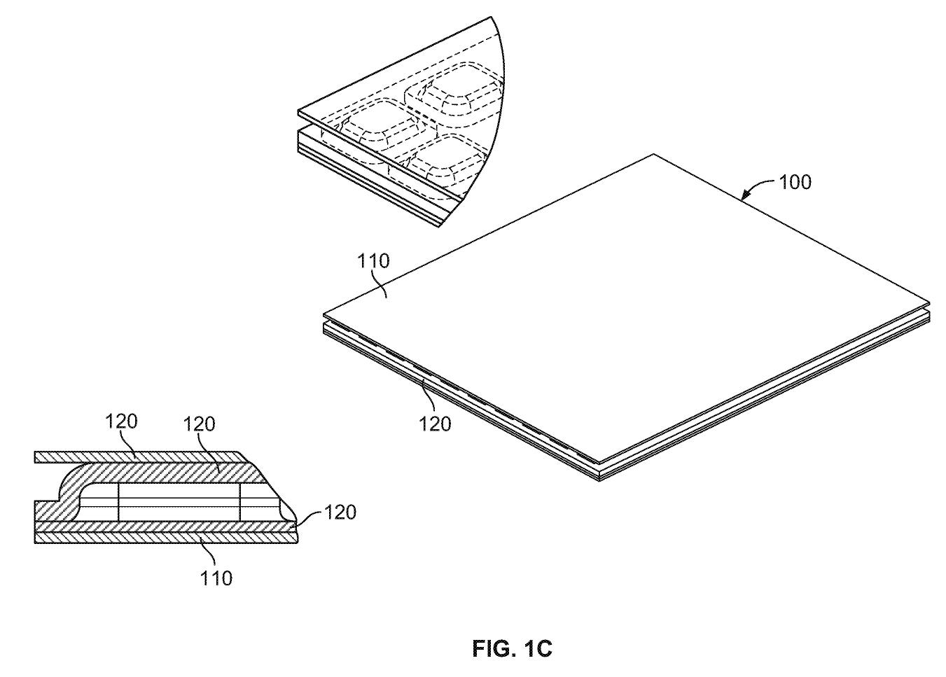

FIGS. 1A-1C illustrate three exemplary embodiments of a laminate with natural fiber composite 100. Referring to FIG. 1A, the laminate 100 includes a flat cover layer 110 and a flat substrate layer 120 that includes a natural fiber composite. The cover layer 110 and the substrate layer 120 are bonded together. The cover layer 110 and the substrate layer 120 may be bonded together using any suitable methods. For example, the cover layer 110 and the substrate layer 120 may be bonded together by impregnating the mating surfaces of the two layers with a suitable amount of a polymer binder, followed by solidifying or curing while the two layers are pressed together to form adequate bonding therebetween.

Referring to FIG. 1B, the laminate 100 includes a flat cover layer 110 and a flat substrate layer 120 that includes a natural fiber composite. The substrate layer 120 includes three separate pieces of the natural fiber composite that are bonded together. The upper composite piece and the lower composite piece are flat, while the middle composite piece has a ridged design. The upper composite piece and the middle composite piece are bonded together at the ridge peaks of the middle composite piece, and the lower composite piece and the middle composite piece are bonded together at the ridge valleys of the middle composite piece. The upper or lower composite piece may be bonded to the middle composite piece using any suitable methods. For example, the upper or lower composite piece may be bonded to the middle composite piece by impregnating the mating surfaces of the two pieces to be bonded together with a suitable amount of a polymer binder, followed by solidifying or curing while the two pieces pressed together to form adequate bonding therebetween. The cover layer 110 and the upper composite piece of the substrate layer 120 are also bonded together.

Referring to FIG. 1C, the laminate 100 includes a flat cover layer 110 and a flat substrate layer 120 that includes a natural fiber composite. The substrate layer 120 includes three separate pieces of the natural fiber composite that are bonded together. The upper composite piece and the lower composite piece are flat, while the middle composite piece has a waffle pattern. The upper composite piece and the middle composite piece are bonded together at the waffle valleys of the middle composite piece, and the lower composite piece and the middle composite piece are bonded together at the waffle ridges of the middle composite piece. The cover layer 110 and the lower composite piece of the substrate layer 120 are also bonded together.

The cover layer 110 may be made from any suitable materials. For example, the cover layer 110 may be made from woods, veneers, plastics, or counter top materials (e.g., formica).

The substrate layer 120 may be produced in numerous cross-section configurations. For example, the substrate layer 120 may be produced in a solid, honeycomb, or ribbon configuration, or any combination thereof.

The substrate layer 120 includes a natural fiber composite. The natural fiber composite includes natural fibers that are bonded together by a polymer binder. Natural fibers include plant-derived fibers. Representative examples of suitable plant-derived fibers include bast fibers. Bast fibers refer to strong woody fibers obtained chiefly from the phloem of plants. Representative examples of suitable bast fibers include jute, kenaf, hemp, flax, banana, ramie, roselle, and combinations thereof. Other examples of suitable bast fibers include leaf fibers (e.g., fibers derived from sisal, banana leaves, grasses (e.g., bamboo), or pineapple leaves), straw fibers (e.g., fibers derived from wheat straw, rice straw, barley straw, or sorghum stalks), and husk fibers (e.g., fibers derived from corn husk, bagasse (sugar cane), or coconut husk).

The natural fiber composite can contain any suitable amount of the natural fibers. In some embodiments, the natural fibers are about 20 wt % to about 80 wt % of the total weight of the composite. For example, the natural fibers may be greater than about 25 wt %, about 35 wt %, about 65 wt % or about 75 wt % of the total weight of the composite. In some embodiments, the natural fibers are about 30 wt % to about 70 wt % of the total weight of the composite. For example, the natural fibers may be greater than about 40 wt %, about 50 wt % or about 60 wt % of the total weight of the composite. In some embodiments, the natural fibers are about 40 wt % to about 60 wt % of the total weight of the composite. For example, the natural fibers may be greater than about 45 wt % or about 55% of the total weight of the composite.

The natural fibers used in the natural fiber composite can have any suitable linear density (i.e., denier). For example, the natural fibers can have a linear density of about 8 denier to about 18 denier.

The polymer binder used in the natural fiber composite can be any suitable polymer binder. For example, the polymer binder can be a thermoplastic polymer that is capable of at least partially softening or melting when heated so that the natural fibers can be bonded together to form the natural fiber composite. Representative examples of suitable thermoplastic binders include polyester (e.g., polyethylene terephthalate (PET) or glycol-modified PET (PETG)), polyamide (e.g., nylon 6 or nylon 6,6), polyethylene (e.g., high density polyethylene (HDPE) or linear low density polyethylene (LLDPE)), polypropylene, poly(1,4-cyclohexanedimethylene terephthalate) (PCT), and combinations thereof. In some embodiments, the polymer binder includes virgin or recycled polypropylene which has relatively high bonding performance.

Suitable thermoplastic binders, such as polyolefins, can contain coupling, compatibilizing, and/or mixing agents. These agents may improve the interaction and/or bonding between the natural fibers and the thermoplastic binder, thereby yielding a natural fiber composite that may have better mechanical properties. Representative examples of suitable coupling, compatibilizing, and/or mixing agents include titanium alcoholates; esters of phosphoric, phosphorous, phosphonic and silicic acids; metallic salts and esters of aliphatic, aromatic and cycloaliphatic acids; ethylene/acrylic or methacrylic acids; ethylene/esters of acrylic or methacrylic acid; ethylene/vinyl acetate resins; styrene/maleic anhydride resins or esters thereof, acrylonitrilebutadiene styrene resins; methacrylate/butadiene styrene resins (MBS), styrene acrylonitrile resins (SAN); butadieneacrylonitrile copolymers; and polyethylene or polypropylene modified polymers. Such polymers are modified by a reactive group including polar monomers such as maleic anhydride or esters thereof, acrylic or methacrylic acid or esters thereof, vinylacetate, acrylonitrile, and styrene. In some embodiments, the thermoplastic binder includes a polyolefin (e.g., polyethylene or polypropylene) or a copolymer thereof that has maleic anhydride (MAH) grafted thereon.

The coupling, compatibilizing, and/or mixing agents can be present in the thermoplastic binder in any suitable amount. For example, the agents can be present in the thermoplastic binder in an amount of about 0.01 wt % or more, about 0.1 wt % or more, or about 0.2 wt % or more, based on the total weight of the binder. The agents can also be present in the thermoplastic binder in an amount of about 20 wt % or less, about 10 wt % or less, or about 5 wt % or less, based on the total weight of the binder. In some embodiments, the thermoplastic binder contains about 0.01 to about 20 wt % or about 0.1 to about 10 wt % of the coupling, compatibilizing, and/or mixing agents, based on the total weight of the binder. The amount of coupling, compatibilizing, and/or mixing agents can also be expressed in term of the number of moles of the coupling, compatibilizing, and/or mixing agents present per mole of the thermoplastic binder. In some embodiments, such as when the thermoplastic binder comprises polypropylene and a maleic anhydride coupling agent, the binder can contain about 5 to about 50 moles of maleic anhydride per mole of the polypropylene polymer.

The polymer binder can also be a thermosetting polymer that when cured is capable of bonding the natural fibers together to form the natural fiber composite. Representative examples of suitable thermosetting binders include polyurethane, epoxy, phenolic and urea.

In some embodiments, the polymer binder includes a biopolymer resin. One representative example of suitable biopolymer resins is biodegradable aliphatic polyesters. Representative examples of suitable biodegradable aliphatic polyesters includes polyesteramides, modified polyethylene terephthalate, polylactic acid (PLA), terpolymers based on polylactic acid, polyglycolic acid, polyalkylene carbonates (such as polyethylene carbonate), polyhydroxyalkanoates (PHA) (e.g., polyhydroxybutyrates (PHB), polyhydroxyvalerates (PHV), polyhydroxybutyrate-hydroxyvalerate copolymers (PHBV), homopolymers and copolymers thereof, combinations thereof), and the like. Other examples of suitable biodegradable aliphatic polyesters include aliphatic polyesters with repeating units of at least 5 carbon atoms (e.g., polycaprolactone), and succinate-based aliphatic polymers (e.g., polybutylene succinate, polybutylene succinate adipate, and polyethylene succinate). More examples of suitable biodegradable aliphatic polyesters include polyethylene oxalate, polyethylene malonate, polyethylene succinate, polypropylene oxalate, polypropylene malonate, polypropylene succinate, polybutylene oxalate, polybutylene malonate, polybutylene succinate, polyethylenedecane dioate and polyethylenetridecane dioate and copolymers of these compounds and a diisocyanate or a lactide.

In some embodiments, the biodegradable aliphatic polyester includes a polylactic acid (PLA) resin which has excellent heat resistance and hardness and can reliably bond the natural fibers. Polylactic acid refers to homopolymers of lactic acid, such as poly(L-lactic acid); poly(D-lactic acid); and poly(DL-lactic acid), as well as copolymers of lactic acid containing lactic acid as the predominant component and a small proportion of a copolymerizable comonomer, such as 3-hydroxybutyrate, caprolactone, glycolic acid, and the like. In some embodiments, the polylactic acid includes an additive such as flame retardant, antistatic agent or antioxidant.

Polylactic acid can be prepared by the polymerization (e.g., polycondensation or ring-opening polymerization) of lactic acid or lactide. In polycondensation, L-lactic acid, D-lactic acid, or a mixture thereof may be directly subjected to dehydro-polycondensation. In ring-opening polymerization, a lactide that is a cyclic dimer of lactic acid may be subjected to polymerization with the aid of a polymerization-adjusting agent and catalyst. The lactide may include L-lactide, D-lactide, and DL-lactide (a condensate of L-lactic acid and D-lactic acid). Each of these lactides (i.e., L-lactide, D-lactide, and DL-lactide) is a dimer; that is, they are comprised of two lactic acid units. As a result of its chiral center, lactic acid has two different stereochemical isomers; R isomer and S isomer configurations. D-lactide includes two R isomers, L-lactide includes two S isomers, and DL-lactide includes an R isomer and an S isomer. The various isomers may be mixed and polymerized, if necessary, to obtain polylactic acid having any desired composition and crystallinity. A small amount of a chain-extending agent (e.g., a diisocyanate compound, an epoxy compound or an acid anhydride) may also be employed to increase the molecular weight of the polylactic acid. In some embodiments, the weight average molecular weight of the polylactic acid is within the range of about 60,000 to about 1,000,000.

Lactic acid and lactide are asymmetrical molecules; they have two optical isomers, one is the levorotatory (“L”) enantiomer and the other is the dextrorotatory (“D”) enantiomer. By polymerizing a particular enantiomer or by using a mixture of the two enantiomers, it is possible to prepare different polymers that are chemically similar yet have different properties. In particular, by modifying the stereochemistry of a polylactic acid polymer in this manner it is possible to control, for example, the melting temperature, melt rheology, and crystallinity of the polymer.

The biopolymer resins may be derived from a vegetable oil such as soy oil. In some embodiments, the biopolymer resin is derived from a soy polyol. Soy polyols can be prepared by reacting maleated or fumarated soybean oils with polyols such as ethylene glycol, pentaerythritol, and trimethyl propane, and the like and their salts.

The biopolymer resins may also be derived from a sugar. Representative examples of suitable sugars include monosaccharides such as glucose, mannose and fructose; disaccharides such as sucrose, lactose, maltose, trehalose; and trisaccharides such as raffinose. In some embodiments, the biopolymer resin includes a ploy(sugar acrylate). Poly(sugar acrylates) can be prepared by addition polymerization of sugar acrylate that can be produced by reacting a mixture of sugar and acrylate in an organic solvent in the presence of an enzyme.

Other examples of suitable biopolymer resins include plant-based compounds such as acetyl cellulose resins and chemically modified starch resins.

The natural fiber composite may be prepared as follows. Unordered natural fibers are first carded manually or by a machine so as to order the natural fibers and remove the tangles. In the carding process, raw or washed natural fibers are brushed to produce webs of natural fibers. The carding process can mix different types of natural fibers together and create a homogeneous mixture thereof. After the natural fibers are carded, the resultant webs of natural fibers are cross-lapped to produce nonwoven battings of natural fibers. The natural fibers are then blended with a suitable amount of a polymer binder, followed by laying the mixture in a mat that is air or dry needle punched so as to stitch together by mechanically interlocking and orienting the fibers and by densifying the web to produce a finished configuration. The web is then heated to a temperature sufficient to activate the polymer binder. The polymer binder binds the natural fibers together, producing a dimensionally stable web. In some embodiments, the nonwoven web is not compressed during the polymer binder activation process; alternatively, some degree of compression of the web may be used.

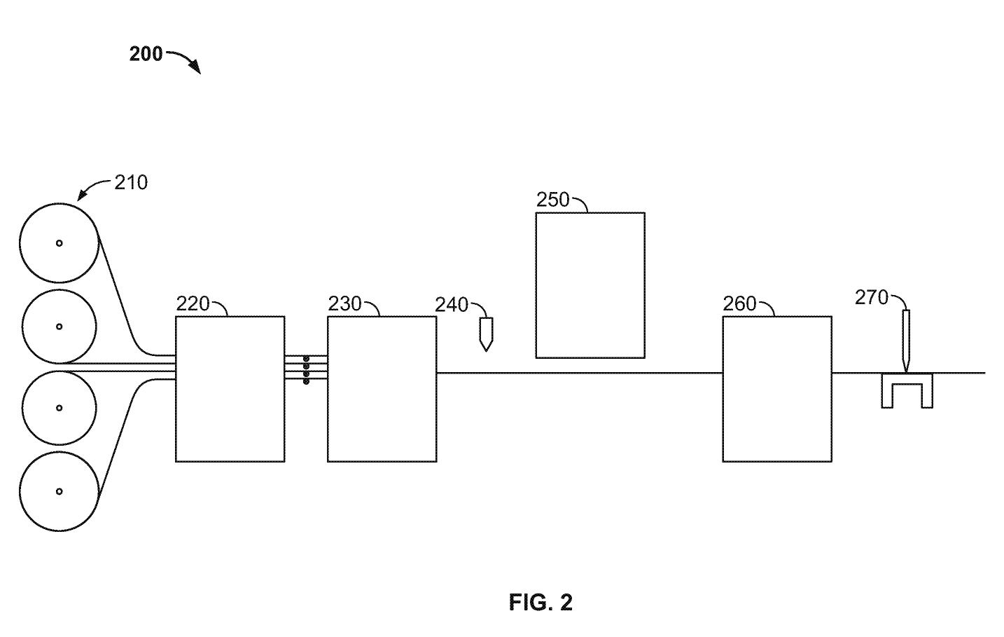

FIG. 2 illustrates an exemplary process 200 for making a laminate with natural fiber composite. The process 200 includes impregnating with a binder polymer the mating surfaces of a substrate layer having natural fiber composite and a cover layer, heating the two layers to activate the binder polymer, applying pressure and cooling to permanently bond the two layers together, and trimming sides and cutting to length. Natural fiber composite rolls 210 may feed multiple pieces of natural fiber composite to a pre-heater 220 where the composite pieces are pre-heated to a predetermined temperature. The pre-heated composite pieces are then fed into a heated laminator 230 where the composite pieces are laminated into a substrate layer with a desired configuration. A polymer tank 240 impregnates the mating surface of the substrate layer with a binder polymer. A cover material feeder 250 then lays a cover layer over the mating surface of the substrate layer. Consequently, the mating surface of the cover layer is also impregnated with the binder polymer. A construct of the cover layer and the substrate layer is therefore formed where the mating surfaces of the two layers are impregnated with the binder polymer. The construct is then fed into a laminator 260 where the cover layer and the substrate layer are permanently bonded together. The laminator 260 heats the construct to activate the binder polymer and applies pressure to press the two layers firmly together. The laminator 260 then cools the construct under pressure for a predetermined time to allow the binder polymer to solidify or cure to form adequate bonding between the cover layer and the substrate layer. After the two layers are laminated together, the laminate are trimmed at the edges and cut to proper length at the cut off station 270 to provide a finished laminate with natural fiber composite. The finished laminate has biodegradability that can reduce the environmental load on final disposal.

The laminate described herein may be used in a variety of applications. For example, the laminate can be used as work surface such as tabletops, writing boards, and the like. The laminate can also be used to make burial containers or accessories such as coffins, cremation urns and the like. The laminate can further be used to make interior or exterior doors such as closets, beds, fronts and the like. The laminate can be used to make shelving such as bookshelves, display shelves, cabinets, buffets and the like. The laminate can also be used to make storage containers such as file boxes, storage bins, storage drawers and the like. The laminate can further be used as automobile interior or exterior material or building material.

A number of embodiments of the invention have been described. Nevertheless, it will be understood that various modifications may be made without departing from the spirit and scope of the invention. Accordingly, other embodiments are within the scope of the following claims.

What is claimed is:

1. An article comprising a laminate that includes a cover layer and a substrate layer, said substrate layer comprising a natural fiber composite that includes natural fibers that are bonded together by a polymer binder, said article is selected from the group consisting of work surfaces, burial containers or accessories, interior or exterior doors, shelving, storage containers, automobile interior or exterior materials, building materials, and combinations thereof.

2. The article of claim 1, wherein the cover layer comprises woods, veneers, plastics, or counter top materials.

3. The article of claim 1, wherein the substrate layer includes ridges, waffles, honeycombs, ribbons or combinations thereof.

4. The article of claim 1, wherein the natural fibers comprise bast fibers.

5. The article of claim 4, wherein the bast fibers are selected from the group consisting of hemp, kenaf, jute, flax, banana, and combinations thereof.

6. The article of claim 1, wherein the polymer binder comprises a thermoplastic polymer.

7. The article of claim 6, wherein the thermoplastic polymer comprises a polypropylene.

8. The article of claim 1, wherein the polymer binder comprises a thermosetting polymer.

9. The article of claim 1, wherein the polymer binder comprises a biopolymer resin.

10. The article of claim 9, wherein the biopolymer resin comprises a biodegradable aliphatic polyester.

11. The article of claim 10, wherein the biodegradable aliphatic polyester comprises a polylactic acid (PLA).

12. The article of claim 9, wherein the biopolymer resin is derived from a soy polyol.

13. The article of claim 9, wherein the biopolymer resin is derived from a sugar.

14. The article of claim 1, said article is a work surface.

15. The article of claim 1, said article is a burial container or accessory.

16. The article of claim 1, said article is an interior or exterior door.

17. The article of claim 1, said article is shelving.

18. The article of claim 1, said article is a storage container.

19. The article of claim 1, said article is an interior or exterior material.

20. The article of claim 1, said article is a building material.
